(19) United States
(12) Patent Application Publication
(10) Pub. No.: US 2010/0220350 A1
(43) Pub. Date: Sep. 2, 2010

(54) Systems and Methods for Configuration of Networked Printers

(75) Inventor: Hassaan Faridi, Broomfield County, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/395,471

(22) Filed: Feb. 27, 2009

(51) Int. Cl. G06F 3/12

(52) U.S. Cl. 358/1.15

(57) ABSTRACT

Methods disclosed permit the configuration of printers coupled to a network. In some embodiments, a configuration message received over a network may be parsed at a printer to extract configuration information local to the printer and configuration information external to the printer. Local configuration information is used to update configuration settings on the printer. Messages are also sent to clients managed by the printer using configuration information for the clients included in the external configuration information. In some embodiments, the configuration messages may take the form of e-mail messages and/or PJL commands.

### BACKGROUND

1. Field of the Invention

The present invention relates to the field of printing and in particular, to systems and methods for automatically configuring print devices.

2. Description of Related Art

Computer printers, which are ubiquitous in most modern organizations, permit the quick printing of stored documents. Designers of modern printers have focused relentlessly on improving printer speed, efficiency, color accuracy, and cost resulting in virtually universal adoption of printers. Nevertheless, in order to optimize resource usage, most organizations use a network of high speed printers to serve people in the organization. Because these high speed printers may be accessed seamlessly over computer networks, most users served by a high-speed network printer will experience very little or no delay when printing documents. In addition, networking allows the system to be fault tolerant and permits users to switch to other printers when a printer malfunctions or demands service.

Network access also helps in the efficient management of printer networks by permitting the remote configuration and administration of printers that are coupled to the network. However, for reasons of security, network administrators typically limit the number of devices in a LAN, subnet, or WAN, that have access to external resources. For example, one of the devices in a subnet may be designated as a “gateway” for the subnet and may relay external requests to and responses from devices within the subnet. Thus, the gateway can be the focus of measures to protect the subnet, increase security, and prevent unauthorized access to and from the subnet, thereby facilitating the deployment of security infrastructure.

While secure gateways can contribute to increased security, they may limit the ability of remote administrators (who may be outside the subnet, LAN, or WAN) to remotely configure printers within the network served by the gateway. Moreover, even in the absence of gateways, the process of remotely configuring individual printers one-by-one is cumbersome. Accordingly, there is a need for systems and methods for the quick and flexible configuration of printing devices deployed on a network.

### SUMMARY

Consistent with embodiments disclosed herein, systems and methods for configuring a plurality of printers coupled to a network are presented. In some embodiments, a method for configuring a plurality of printers coupled to a network comprises: parsing at least one first configuration message received over the network at a first printer identified in the first configuration message to extract configuration information local to the first printer and configuration information external to the first printer; updating local configuration settings on the first printer in accordance with the local configuration information; and transmitting at least one second configuration message over the network to at least one client printer managed by the first printer using the external configuration information.

Embodiments also relate to software, firmware, and program instructions created, stored, accessed, or modified by processors using computer-readable media or computer-readable memory. The methods described may be performed on a computer and/or a printing device.

These and other embodiments are further explained below with respect to the following figures.

### BRIEF DESCRIPTION OF THE DRAWINGS

FIG. 1 shows a block diagram of exemplary system 100 for managing networked printing systems.

FIG. 2 shows a high level block diagram of an exemplary printer.

FIG. 3 shows an exemplary system for the configuration of networked printers consistent with disclosed embodiments.

FIG. 4 shows a flowchart illustrating steps in a method for the configuration of networked printers.

### DETAILED DESCRIPTION

In accordance with embodiments disclosed herein, systems and methods for automatically configuring networked printing devices are presented.

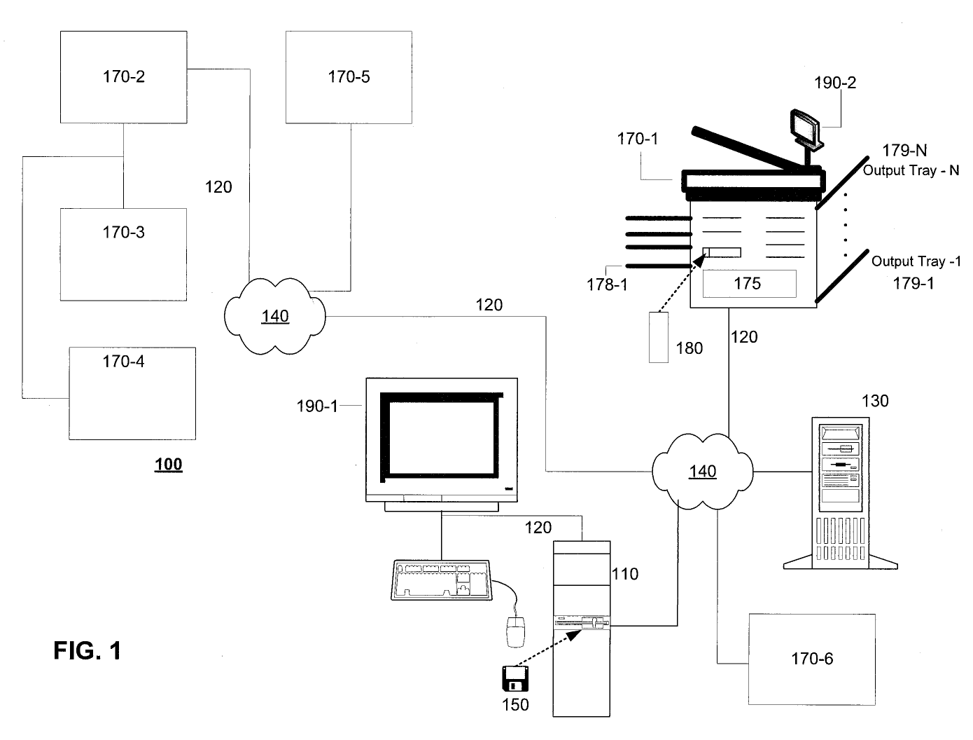

FIG. 1 shows a block diagram of exemplary system 100 for managing the configuration of networked printing systems. A computer software application for networked printer configuration may be deployed on a network of computers and/or printers, as shown in FIG. 1, that are connected through communication links that allow information to be exchanged using conventional communication protocols and/or data port interfaces.

As shown in FIG. 1, exemplary system 100 includes a computer or computing device 110 and a server 130. Further, computing device 110 and server 130 may communicate over a connection 120, which may pass through one or more networks 140, which in one case could be the Internet. Networks 140 may include subnets, LANs, and/or WANs. Further, network 140 may also include modems, routers, repeaters, and other communication devices (not shown) that permit devices that are coupled to a network 140 to communicate with other devices in accordance with the policies set by a network administrator. For example, as shown in FIG. 1, printers 170-2, 170-3, and 170-4 form a subnet, and printer 170-2 can serve as the gateway to the subnet.

Computing device 110 may be a computer workstation, desktop computer, laptop computer, or any other computing device capable of being used in a networked environment. Server 130 may be a platform capable of connecting to computing device 110 and other devices too (not shown). Computing device 110 and server 130 may be capable of executing software (not shown) that allows the configuration and printing of documents on printers 170-1 through 170-6.

Printers 170 may be laser printers, ink jet printers, LED printers, plotters, and various other types. From a functional perspective, printers 170 may take the form of computer printers, facsimile machines, digital copiers, multi-function devices, and/or various other devices that are capable of printing documents. Computing device 110 may contain a removable media drive 150. Removable media drive 150 may include, for example, 3.5 inch floppy drives, CD-ROM drives, DVD ROM drives, CD+RW or DVD±RW drives, USB flash drives, Memory Sticks™, Secure Digital High Capacity (“SDHC”) cards, and/or any other removable media drives consistent with embodiments of the present invention. Portions of software applications may reside on removable media and be read and executed by computing device 110 using removable media drive 150. In some embodiments, intermediate and final results and/or reports generated by applications may also be stored on removable media.

Connection 120 couples computing device 110, server 130, and printers 170-1-170-6 to networks 140. Connection 120 may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB™, SCSI, FIREWIRE™, and/or BNC ports for transmission of data through the appropriate connection 120. The communication links could be wireless links or wired links or any combination that allows communication between computing device 110, server 130, and printers 170.

Networks 140 could include a LAN, a WAN, or the Internet. Printers 170, such as exemplary printer 170-2, may be network printers that can be coupled to network 140 through connection 120. System 100 may include multiple printers 170 and other peripherals (not shown), according to embodiments of the invention. Some printers 170 may reside on the same subnet, while others may reside on the same LAN, and others may be accessible through the WAN.

In some embodiments, one or more of the printers 170 may serve as a master printer. For example, exemplary printer 170-1 may take the form of a master printer that can communicate with other printers 170-2-170-6 over network 140. Similarly, printer 170-2 may serve as a master printer for printers 170-3 and 170-4. In some embodiments, communication between master printer 170-1 and printers 170-2-170-6 may include configuration messages. Configuration messages between printers may take the form of e-mails, print job language (“PJL”) commands and data, or any other agreed upon protocol. In some embodiments, configuration messages may be packaged with print jobs sent to a printer.

Printers 170 may be controlled by hardware, firmware, or software, or some combination thereof. Printers 170 may include one or more print controller boards 175, which may control the operation of printers 170, and may also perform portions of configuration functions. Printers 170 may be controlled by firmware or software resident on memory devices in print controller 175. In general, print controller 175 may be internal or external to printers 170. In some embodiments, printers 170 may also be controlled in part by software, including print servers, printer drivers, or other software, running on computing device 110 or server 120.

Printers, such as exemplary printer 170-1, may also include console 190 such as consoles 190-1 and 190-2, or other interfaces to allow configuration options to be set, passwords and/or user identification and authentication information to be entered, and other messages to be displayed. In some embodiments, configuration options may be set or displayed using a display or user-interface on a monitor for a computer coupled to printers 170. For example, user interfaces to set one or more configuration options on printer 170-1 may be displayed on console 190-1. In some embodiments, a user interface to set configuration options on printers 170-2-170-6 may also be displayed on console 190-1, and appropriate configuration messages may be sent to printers 170-2-170-6 based on their individual configuration settings. For example, the print resolution, document sizes, color options, and other configuration parameters may be user-configurable.

Users may also be able to log in to a printer 170 to perform administrative functions such as to enable software or firmware on printer 170 to perform various functions. In some embodiments, the log in process may require a password or other user-authentication mechanism. A user may also be able to specify input trays 178 and/or output trays 179 and the use of automatic document feeders to allow batch processing of documents. Printers 170 may have multiple input trays 178 and/or output trays 179. Output trays 179 can hold printed documents that have been processed by a printer.

A computer software application to configure networked printers may be deployed on any of the exemplary computers 110, server 130, and/or printers 170, as shown in FIG. 1. For example, computing device 110 could execute software, such as a user interface coupled to a print driver, to allow users to configure, control, and/or monitor the operation of printer 170-1. An independent application may also execute concurrently on printer 170-2 based on its configuration. In another example, an application resident on print controller 175 could be configured using computer 110 but execute on printer 170-1. In general, applications may execute in whole or in part on one or more computers, print controllers, or printers in the system. The embodiments described above are exemplary only and other embodiments and implementations will be apparent to one of reasonable skill in the art.

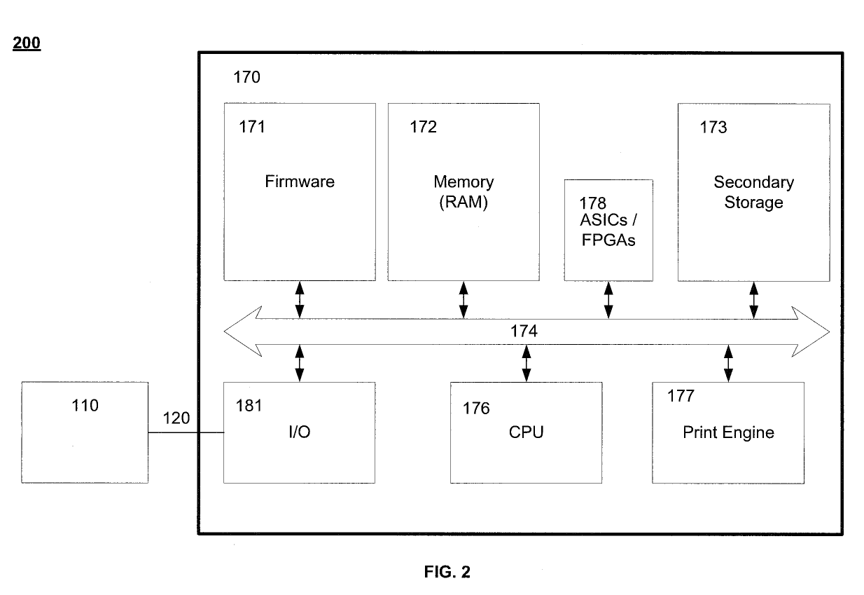

FIG. 2 shows a high-level block diagram of exemplary printer 170 coupled to a computing device 110 over connection 120. Exemplary printer 170 may contain bus 174 that couples CPU 176, firmware 171, memory 172, input-output ports 181, print engine 177, and secondary storage device 173. Exemplary printer 170 may also contain other Application Specific Integrated Circuits (ASICs), and/or Field Programmable Gate Arrays (FPGAs) 178 that are capable of executing portions of an application to configure printers, and to print or process documents. Exemplary printer 170 may also be able to access network 140 as well as secondary storage or other memory in computing device 110 using I/O ports 181 and connection 120. In some embodiments, printer 170 may also be capable of executing software including, a printer operating system, message processing and configuration software, and other appropriate application software. Exemplary printer 170 may allow paper sizes, output trays, color selections, and print resolution, among other options, to be user-configurable.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for processing incoming messages, composing outgoing messages, configuration management, document processing, and other code. In some embodiments, code and data in firmware 171 may be copied to memory 172 prior to being acted upon by CPU 176. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/FPGAs 178 and print engine 177 to generate printed documents. ASICs/FPGAs 178 may also provide control and data to print engine 177. FPGAs/ASICs 178 may also implement one or more of configuration management, message processing, and other print related algorithms.

Intermediate and final printable data, messages, and configuration information pertaining to one or more printers 170 may be stored in memory 172 or secondary storage 173. Exemplary secondary storage 173 may be an internal or external hard disk, or a memory stick, USB drive, SDHC card, flash drive, or any other memory storage device capable of being used by system 200.

In some embodiments, routines to process incoming and outgoing configuration messages may take the form of a message server and message parser running on printers 170, and/or print controller 175. For example, if configuration messages are sent to printers 170 in the form of an e-mail, the message server may take the form of a mail server. The received messages may then be parsed by each printer to extract individual configuration information and transmit configuration information intended for other printers. If PJL is used to send configuration messages, which can be embedded in a print job, then the print job may be pre-processed to extract configuration information. In general, the sending, receiving, and processing of configuration messages may be performed by an appropriate application based on the agreed upon protocol for configuration.

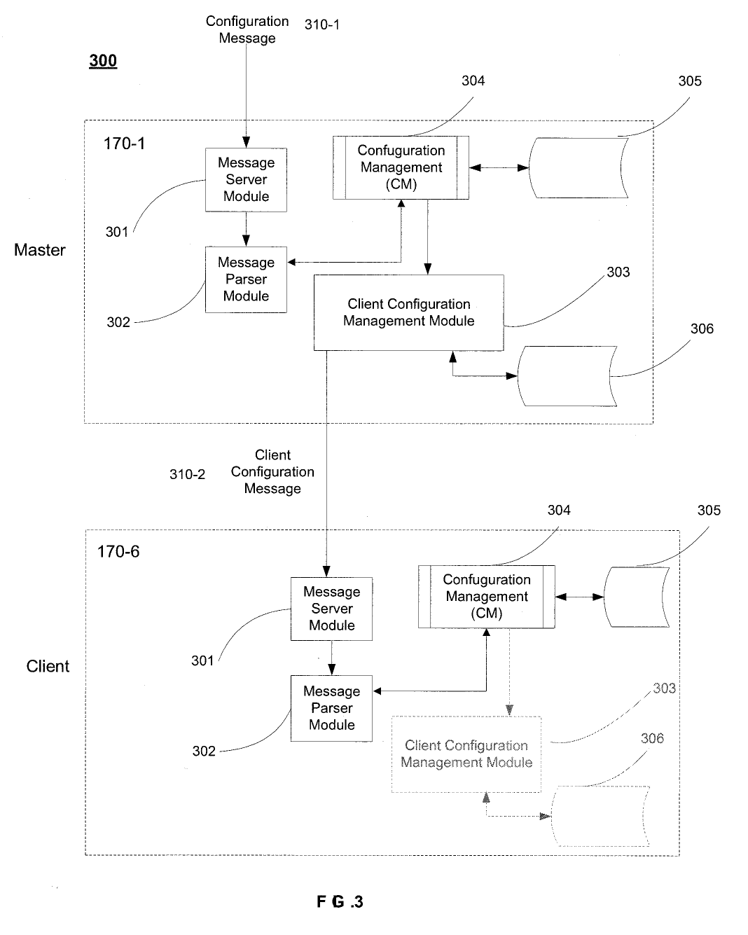

FIG. 3 shows an exemplary system 300 for the configuration of networked printers consistent with disclosed embodiments. As shown in FIG. 3, system comprises two printers 170-1 and 170-6. Although, in general, system 300 may comprise of a number of networked printers in a variety of configurations, for ease of explanation, only two printers have been shown in FIG. 3. The configuration mechanism described below for system 300 may be generalized and applied to any networked printer configuration as would be apparent to one of ordinary skill in the art.

As shown in FIG. 3, configuration message 310-1 is received by printer 170-1. In some embodiments, printer 170-1 may be configured as a “master printer” that may transmit configuration messages 310 to other printers. In some embodiments, the configuration messages 310-1 may be transmitted from a computer to printer 170-1, which may then process and forward configuration messages 310-2 to other computers. In some embodiments, current client printer list 306 comprising clients configured by exemplary master printer 170-1 may be stored in memory 172. In some embodiments, configuration message 310-1 may be received by printer 170-1 over network 140 using I/O ports 181 and connection 120. In some embodiments, the message may be stored in memory 172 prior to being acted upon by CPU 176. In some embodiments, the current configuration 305 of printer 170-1 may also be stored in memory 172.

Message server module 301 may act upon received configuration messages 310-1 and process them in accordance with the agreed protocol for configuration messages 310. In some embodiments, routines to process incoming and outgoing configuration messages 310 may take the form of message server module 301 and message parser module 302.

For example, if configuration messages 310 are sent to printers 170 in the form of an e-mail, message server module 301 may take the form of a mail server. The received e-mail messages may then be parsed by message parser 302, which may take the form of a parser for e-mail messages. In some embodiments, e-mail messages may use the Simple Message Transfer Protocol (“SMTP”). In some embodiments, gateways may be configured to permit the back and forth transfer of message using the SMTP protocol.

If PJL is used to send configuration messages 310, then message server 301 may take the form of a PJL pre-processor, which can pre-process the print job to extract configuration information. The extracted configuration information can then be parsed by message parser 302. Message parser 302 may then send the message to configuration management module 304. In some embodiments, the configuration information output by message parser 302 may be logically partitioned into local configuration information for the printer 170-1 and external configuration information for one or more client printers, such as exemplary client printer 170-6.

In some embodiments, configuration management module 304 may receive configuration information from message parser 302. Configuration management module 304 may use pertinent received local configuration information to configure various components in printer 170-1. For example, configuration management module 304 may update settings pertaining to print engine 177 on printer 170-1. If the local configuration changes are successful, then configuration management module 304 may update current configuration settings 305. If one or more local configuration changes are unsuccessful, configuration management unit may set an error flag or status, or invoke an error handling routine. In some embodiments, configuration management module 304 may separate received configuration information into local configuration information and external configuration information for client printers.

In some embodiments, external client configuration information may be sent to client configuration module 303, where configuration information for individual client printers (such as printer 170-6) may be extracted. The extracted client-specific configuration information may then be sent to individual client printers as individual client configuration messages 310-2. In some embodiments, the extracted client-specific information may be sent to a client printer as an e-mail message. In some embodiments, the extracted client-specific information may be sent to a client printer along with the next print job sent to that client printer. The extracted client-specific information may also be sent to a client printer using PJL. In some embodiments, client printer list 306 may be periodically updated by a system administrator when printers are added, removed, renamed, and/or relocated.

In some embodiments, the client configuration information received by client configuration module 303 may be broadcast as a message to all client printers in client printer list 306, and each client printer may parse the received broadcasted message to obtain configuration information specific to itself and update its configuration in accordance with information in the message. In some embodiments, the broadcast message may not be directly transmitted to client printers 170, which are in other subnets and may be limited to client printers 170 that are in the same subnet as the broadcasting device. In situations where the client printer has downstream clients, the client printer may send out one or more additional configuration messages to the downstream clients according to the protocol in effect. If a client printer has no downstream clients then portions of the broadcast message that include information for other clients can be ignored.

For example, in FIG. 1, in a situation where printer 170-1 is master, a configuration message broadcast by printer 170-1 to other master printers may be received by printer 170-2, which may then send additional configuration messages to downstream clients 170-3 and 170-4. In the above example, printer 170-5, which has no downstream clients, will parse the broadcast message to extract its configuration information (if any) and ignore messages intended for other printers.

Reverting to FIG. 3, in some embodiments, master printer 170-1 may maintain client printer list 306, which may used to obtain address and other information pertaining to the destination client printer. In embodiments where e-mail is being used to send configuration messages, master printer 170-1 may use a network e-mail alias to send an e-mail message with configuration messages. For example, client printer list 306 may comprise of an e-mail alias. The e-mail alias may be stored in memory 172 and may also be configurable. In situations where an e-mail alias is used to send configuration messages, a system administrator can update the various e-mail aliases used by master printer 170-1 to reflect the current master-client configuration of the printer network. In some embodiments, the e-mail alias itself may form part of the configuration of a printer 170, so that the e-mail alias or client printer list 306 used by master printer 170-1 may be changed dynamically as part of the configuration process.

Client configuration message 310-2 may be received by message server module 301 on exemplary client printer 170-6 and processed in accordance with the protocol in use. The message may be parsed by client message parser module 302. Configuration settings intended for client printer 170-6 may be extracted from client configuration message and used to update current configuration 305. In some embodiments, any portion of client configuration message 302 intended for other clients may be ignored, if client printer 170-6 does not have further downstream clients.

In some implementations, the mode in which printer 170 operates may be configurable. For example, if a printer is a master of some clients then the printer may be configured as a master and set up with an appropriate client printer list 306. On the other hand, if a printer is exclusively a client (i.e. the printer has no downstream clients), then the printer may be configured as a client printer. In some embodiments, when a printer is configured as a client, client configuration module 303 and client printer list 306 may be disabled as shown by the gray dotted outlines to these modules in client printer 170-6.

An exemplary message in pseudo-code with configuration options for various printers appears below. In some embodiments, the message may only include changes to current settings on identified client printers. In some embodiments, the message may include a global section that includes configuration changes for all printers listed in the message as well as individualized configuration changes for specific printers. In general, the configuration system may be configured to permit messages of various forms as would be apparent to one of ordinary skill in the art.

Begin Message
Printer_Id: 190.1.32.3
   Change Option 1 to value 5
   Change Option 2 to value 3
Printer_Id: 191.1.32.44
   Change Option 1 to value 7
   Change Option 9 to value 1
   Change Option 13 to value 9
Printer_Id: 191.1.32.9
   Change Option 1 to value 2
   Change Option 7 to value 2
   Change Option 31 to value abc
   Change Option 26 to value xyz

End Message

In the example above, in one implementation the message may be transmitted to the identified printers 190.1.32.3, 191.1.32.44, and 191.1.32.9. In another implementation the message may be transmitted to all gateway printers. In a further implementation, the message may be transmitted to the gateway printers serving the subnet in which the printers identified in the message reside. Accordingly, in some embodiments, the message may be relayed by a gateway printer, if the printers identified in the message are in a subnet served by the gateway printer. Each printer identified in the message may parse the received message and make the appropriate specified configuration changes. For example, the printer identified with the IP address 190.1.32.3 may change the value of its first configuration parameter to 5 and the value of its second configuration parameter to 3. In some embodiments, the message may be sent from a master printer or a computer to all gateway printers, which may parse the message, make any local configuration changes, and then send additional messages to client printers that they serve. Note that printers may be of different types, models, and/or made by different manufacturers. In systems with legacy printers, a print server or controller may perform one or more of message serving, parsing, and/or configuration management.

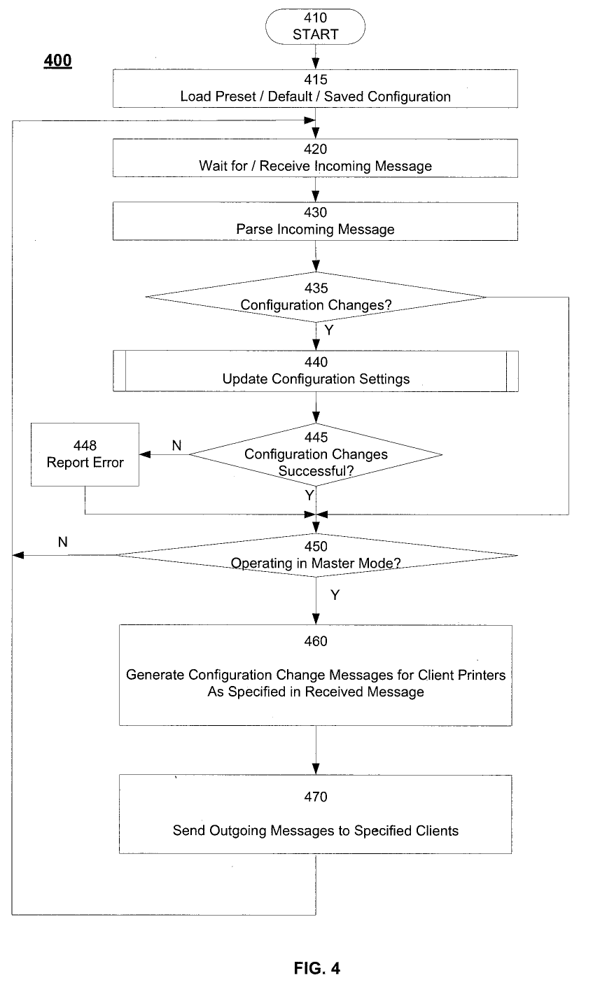

FIG. 4 shows a flowchart 400 illustrating steps in a method for configuration of networked printers. In some embodiments, the method shown in flowchart 400 may be implemented on printers deployed on a network. The algorithm starts in step 410 and in step 415, a preset or default configuration may be loaded initially by a printer 170 deployed on network 140. In some embodiments, the default or preset configuration may be loaded using routine in firmware 171. Printer 170 may wait for and receive an incoming configuration message 310, in step 420. In some embodiments, configuration message 310 may be received using message server module 301.

In step 430, the incoming message may be parsed to extract configuration information. In some embodiments, the parsing may be performed by message parser module 302. If the incoming message contains configuration information specific to the local receiving printer (“Y” in step 435) then, in step 440, the extracted configuration settings are used to update the existing configuration of printer 170. In some embodiments, configuration updates may be performed by configuration management 304. If the incoming message contains no local configuration changes, then the algorithm proceeds to step 450.

If the configuration changes are successful (“Y” in step 445) then, in step 450, the algorithm checks whether printer 170 is operating in master mode. If one or more configuration changes are unsuccessful (“N” in step 445) then, in step 448, an error may be reported before the algorithm proceeds to step 450.

If printer 170 is operating in master mode (“Y” in step 450) then, in step 460, configuration messages specific to any client printers configured by the master are generated. In step 470, the generated client specific messages 310-2 are sent to the various client printers. In some embodiments, client configuration messages 310-2 are generated using client configuration management module 303. The algorithm may then return to step 420. If printer 170 is not operating in master mode (“N” in step 450) then, the algorithm returns to step 420, where it waits for the next incoming configuration message 310.

In some embodiments, a program for conducting the process described in algorithm 400 can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170. In certain embodiments, portions of a program to implement the systems, methods, and structures disclosed may be delivered over network 140.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A method for configuring a plurality of printers coupled to a network, the method comprising:
parsing at least one first configuration message received over the network at a first printer identified in the first configuration message to extract configuration information local to the first printer and configuration information external to the first printer;
updating local configuration settings on the first printer in accordance with the local configuration information; and
transmitting at least one second configuration message over the network to at least one client printer managed by the first printer using the external configuration information.

2. The method of claim 1, wherein the second configuration message is transmitted if the external configuration information includes configuration information for at least one client printer managed by the first printer.

3. The method of claim 1, wherein the first configuration message is an e-mail message.

4. The method of claim 3, wherein the second configuration is transmitted as an e-mail message.

5. The method of claim 4, wherein the second configuration message is transmitted using a network e-mail alias.

6. The method of claim 1, wherein the first and second configuration messages are specified in PJL.

7. The method of claim 6, where the first and second configuration messages are sent along with a print job.

8. The method of claim 1, wherein the first printer and the at least one client printer managed by the first printer are in a subnet.

9. The method of claim 8, wherein the first printer serves as a gateway to client printers managed by the first printer.

10. The method of claim 1, wherein the first configuration message is broadcast to printers on the network and the second configuration message is broadcast to the client printers managed by the first printer.

11. The method of claim 1, wherein transmitting at least one second configuration message over the network to at least one client printer managed by the first printer using the external configuration information further comprises:
composing at least one client specific message to the client printer, wherein the client specific message includes configuration information specific to the client printer; and
sending the client specific image to the client printer.

12. The method of claim 1, wherein the first configuration message is sent from one of a master printer, or a computer coupled to the network.

13. The method of claim 1, wherein the second configuration message includes configuration information for downstream client printers managed by the at least one client printer.

14. A computer-readable medium that stores instructions, which when executed by a processor performs steps in a method for configuring a plurality of printers coupled to a network, the steps comprising:
parsing at least one first configuration message received over the network at a first printer identified in the first configuration message to extract configuration information local to the first printer and configuration information external to the first printer;
updating local configuration settings on the first printer in accordance with the local configuration information; and
transmitting at least one second configuration message over the network to at least one client printer managed by the first printer using the external configuration information.

15. The computer-readable medium of claim 14, wherein the first configuration message is an e-mail message.

16. The computer-readable medium of claim 15, wherein the second configuration is transmitted as an e-mail message.

17. The computer-readable medium of claim 16, wherein the second configuration message is transmitted using a network e-mail alias.

18. The computer-readable medium of claim 14, wherein the first and second configuration messages are specified in PJL.

19. The computer-readable medium of claim 18, where the first and second configuration messages are sent along with a print job.

20. The computer-readable medium of claim 14, wherein the first configuration message is broadcast to printers on the network and the second configuration message is broadcast to the client printers managed by the first printer.

21. The computer-readable medium of claim 14, wherein the second configuration message includes configuration information for downstream client printers managed by the at least one client printer.
